(19) United States
(12) Patent Application Publication
(10) Pub. No.: US 2015/0129624 A1
(43) Pub. Date: May 14, 2015

(54) ANTERIOR LOAD CARRIAGE STABILITY & MOBILITY SUPPORT SYSTEM

(71) Applicants: ANDREA MICHELLE SUMNER, FAYETTEVILLE, NC (US); WENDI WEIMAR, AUBURN, AL (US); SARA ELIZABETH WOLF, AUBURN, AL (US)

(72) Inventors: ANDREA MICHELLE SUMNER, FAYETTEVILLE, NC (US); WENDI WEIMAR, AUBURN, AL (US); SARA ELIZABETH WOLF, AUBURN, AL (US)

(73) Assignee: AUBURN UNIVERSITY, AUBURN, AL (US)

(21) Appl. No.: 14/079,780

(22) Filed: Nov. 14, 2013

(51) Int. Cl. G10D 13/00; A45F 3/10

(52) U.S. Cl. CPC G10D 13/00; A45F 3/10
USPC 224/265

(57) ABSTRACT

The present invention relates generally to the field of an anterior load carriage stability and mobility support system, and more particularly to marching and equipment and marching drum stability and mobility support belt for a marching drummer in K-12 primary or secondary, a collegiate, a drum and bugle corps or the like. A device capable of providing a support mechanism for the lumbar region of a user's back that allows for load distribution from loads placed anteriorly and inferiorly to the drummer's body. A preferred embodiment of the device includes a large piece and two smaller pieces of neoprene fabric, dual straps sewn along the sides of the belt, removable commercial grade closed cell foam sheets, and two plastic tubing for a sturdy structure with flexibility and versatility, and Velcro® sewn along the straps and on the obverse side of the belt for easy and secure attachment of the straps.

### CROSS-REFERENCE TO RELATED APPLICATION

This Application is a Non-Provisional Application which claims priority to and benefit under 35 U.S.C. §11(e) to U.S. Provisional Patent Application Ser. No. 61/726,266, filed Nov. 14, 2012, the content of which is incorporated herein by reference in its entirety.

### STATEMENT REGARDING FEDERALLY SPONSORED RESEARCH

Not Applicable.

### TECHNICAL FIELD OF THE INVENTION

The present invention relates generally to the field of load carriage support systems, and more particularly to marching bands and equipment and to a marching drum stability and mobility support belt.

### BACKGROUND OF THE INVENTION

Each year thousands of students participate in marching bands. Many participate by carrying a flag, baton, woodwind or brass instrument, or a percussion instrument, i.e., drum. These musicians perform demanding and strenuous movements, and a particular group of musicians perform these movements while carrying large cumbersome loads. The drumline is of particular interest due to the unique and restricting nature of the instrument: a load carried anterior to the body with the only points of contact on the body at the shoulders and across the abdominal area. The influence of load carriage research on gait and joint mechanics, muscle activity, and contact pressure can be seen in the ever changing backpack designs and recommendations of load mass, however, there still remains a lack of research on marching band load carriage.

Many load carriage professions and recreational activities utilize a lumbar belt as part of the lift belt, hiking pack, or military rucksack to help dissipate the weight of the load between the shoulders, trunk, and pelvis. This background knowledge of the environments in which lumbar belts are already being used is what began the initial thought of how to utilize this load carriage tool for the marching band members, particularly since their load carriage situations are similar and yet so unique. The existing technology is fairly consistent across the industries: military, hiking, ergonomics. The belt is either form-fitting or stuffed with a small amount of padding, cut to lie in the small of the back. Some designs will wrap around the sides of the trunk and over the pelvic bones, but either the padding does not continue around the body or the connection of the belt is at the abdominal region which would interfere with the drum carrier's belly or abdominal plate. The general attachment techniques include using Velcro® to attach the two side pieces to each other, or using a buckle that will snap across the abdomen.

The predominate use of these lumbar belts is for loads that are being carried on the back part of the body. Thus, it can be seen that needs exist for improved marching drum stability and mobility support belt that allows for load distribution from loads placed on the front of the body.

At this time, however, it can be seen that the concept of using a belt that will connect to a drum carrier has been established prior to this invention's disclosure. The prior art utilizes a belt designed to attach via a buckle and/or Velcro® connectors to a drum carrier. Such a device has been disclosed in, for example, U.S. patent application Ser. No. 13/305,068 and U.S. Pat. No. 7,671,261.

Momose, however, did not teach the use of a belt for back support U.S. Pat. No. 7,671,261, but, rather, only for the purpose of bringing the drum closer to the user's body via a fixed positioning and guiding path of the belt. However, there are still many differences between the prior art and the present invention, as the features of the present invention will become more fully apparent from the following description and appended claims, or may be learned by the practice of the invention as set forth hereinafter.

### BRIEF SUMMARY OF THE INVENTION

In example embodiments, the present invention provides an anterior load carriage stability and mobility support system.

The present concept embodiments are directed to a marching drum stability and mobility support belt used by a drummer in a K-12 primary or secondary education or collegiate marching band, as well as professional drum and bugle corps or the like. This includes, but is not limited to, those individuals who march snare drums, tenor drums, bass drums or the like. The drumline is of particular interest due to the unique and restricting nature of the instrument: a load carried anterior to the body with the only points of contact on the body at the shoulders and across the abdominal area. The influence of load carriage research on gait and joint mechanics, muscle activity, and contact pressure can be seen in the ever changing backpack designs and recommendations of load mass; however, there still remains a lack of research on marching band load carriage.

The marching drum stability and mobility support belt has a plurality of unique characteristics from the prior art including the neoprene fabric, which is able to withstand the perspiration from the marchers and can be washed for continued use.

The present invention further comprises at least one strap that is sewn along the edges on the side of the support belt, allowing for strength and security when the marching drummers pull on the at least one strap to tighten the support belt.

In addition, another unique characteristic of the present invention is the variable placement, flexibility, and versatility of being able to attach the support belt to any location on the drum carrier. More specifically, the present invention is capable of reversibly fastening the at least one strap of the support belt to a plurality of points on the drum carriage apparatus via Velcro®, a buckle, a clasp or the like, according to needs of the individual marching drummer and also where the line of pull of the at least one strap is based on the location of the drum to the body of the user.

The present invention may further comprise the unique characteristic of the at least one sheet of commercial grade yet affordable closed cell foam that not only absorbs some of the weight off of the drum system but also provides support to the lower back of the marching drummers, and, consequently, provides comfort to the marching drummers. The at least one sheet of closed cell foam is also cut to fit the dimensions of each support belt based on the size determined by each individual marching drummer's respective measurements.

Another unique characteristic of the present invention is the at least one removable plastic tubing that provides a sturdy structure to the support belt, which has the flexibility of curving around and following the contour of the individual marching drummer's back area.

The present invention still further comprises the unique characteristic of the Velcro® sewn along the at least one strap and on the obverse side of the support belt for easy and secure attachment of the at least one strap, in addition to being able to have the at least one strap lie flush against the body versus a buckle that could potentially create a hot spot against the marching drummer's body.

These features and advantages of the invention will become more fully apparent from the following description and appended claims of the preferred embodiments thereof, or may be learned by the practice of the invention as set forth hereinafter.

### BRIEF DESCRIPTION OF THE DRAWINGS

A more complete understanding of the present invention and benefits thereof may be acquired by referring to the following description taken in conjunction with the accompanying drawings, in which:

FIG. 1 shows an elevational perspective view of the obverse side of a marching drum stability and mobility support belt in the open position according to an example embodiment of the present invention;

FIG. 2 shows an elevational perspective view of the inverse side of a marching drum, stability and mobility support belt in the open position according to an example embodiment of the present invention shown in FIG. 1, wherein the two separate layers of neoprene are detached from the Velcro® strip, showing the enclosed two removable commercial grade closed cell foam sheets;

FIG. 3 shows an enlarged fragmented side elevational perspective view of a marching drum stability and mobility support belt with the right side strap in the fastened position, attaching and fastening via Velcro® by looping around the J-rod of a marching drum carriage apparatus;

FIG. 4 shows a side perspective view of a marching drum stability and mobility support belt with the right side strap in the fastened position, attaching and fastening via Velcro® by looping around the tubular member of a marching drum carriage apparatus worn by a marching drummer or user according to an example embodiment of the present invention; and

FIG. 5 shows a front perspective view of a marching drum stability and mobility support belt with the left side and right side straps in the fastened position, attaching and fastening via Velcro® by looping around the tubular members of a marching drum carriage apparatus worn by a marching drummer or user according to an example embodiment of the present invention.

### DETAILED DESCRIPTION OF THE INVENTION

As has been mentioned, the present description of the invention is about a load carriage support system, and more particularly to marching bands and equipment and to a marching drum stability and mobility support belt made for the marching drummer.

The apparatus of the present invention is the result of the inventors' discovery that developing a marching drum mobility and stability belt that provides support and comfort for the drummer can significantly enhance the performance of the marching drummer, drumline, and overall marching band or drum corps. The present inventors further provide improvements over the lumbar belts on the market by providing a marching drum stability and mobility support belt that is more comfortable for the drummer with a potential decrease in the occurrence of an injury, and anecdotally providing relief to the participants while standing, walking, or marching.

Reference throughout this specification may be expressed herein, including in the claims, as the terms “back”, “lower back”, or “lumbar region” when applied to the support belt area disclosed herein, meaning that the device is capable of providing support for the posterior musculature of the user's trunk and pelvis including, but not limited to, the erector spinae.

Similarly, as used in the specification including the appended claims, the terms “belly” or “abdominal region” when applied to the support belt area disclosed herein, meaning that the device is capable of providing a more efficient demand of the anterior musculature of the user including, but not limited to, the abdomen or the pelvis.

Additionally, as used in the specification including the appended claims, the singular forms “a,” “an,” and “the” include the plural, and reference to a particular numerical value includes at least that particular value, unless the context clearly dicta otherwise.

Detailed descriptions of the preferred embodiment are provided herein. It is to be understood, however, that the present invention may be embodied in various forms. The specific details disclosed herein are not to be interpreted as limiting, but, rather, as a basis of illustrating the general principles of the invention. Although the exemplary implementations are described below in the context of a marching drum stability and mobility support belt, it is to be further understood that the present invention may be embodied in various fields including, but not limited to, patient assistance, patient transport, general load carrying or the like. The present invention can further be applicable to other fields including those yet to be developed.

Embodiment of tie present invention are now described in more detail.

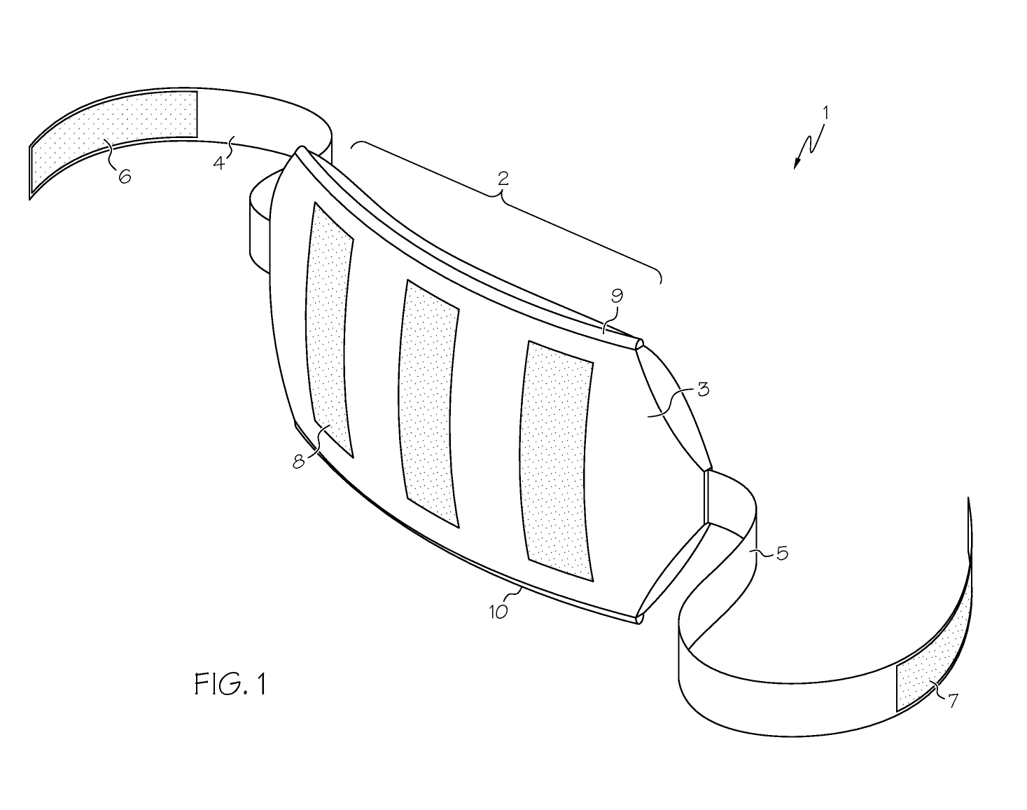

Referring now to FIG. 1, are elevational perspective view of the obverse side of a marching drum stability and mobility support belt 1 in the open position according to an example embodiment of the present invention. The support belt 1 comprises a support mechanism 2 with the capability of providing support for the posterior musculature of a user's back. The support mechanism 2 can further provide a more efficient demand of the anterior musculature of the user. The support mechanism 2 can still further provide comfort for the user by reducing the amount of contact pressure at the shoulders by redistributing those pressures to the abdominal region and pelvis.

In the preferred embodiment of the invention, the marching drum stability and mobility support belt 1 comprises a left side strap 4 and a right side strap 5 capable of attaching at the edges of the support belt 1 by sewing with heavy-duty thread. The two straps 4, 5 comprising a left side Velcro® attachment 6 and a right side Velcro® attachment 7 on each strap by sewing with heavy-duty thread. The materials of the two straps 4, 5 are nylon and polyester.

The marching drum stability and mobility support belt 1 further comprises a top removable plastic tubing 9 and a bottom removable plastic tubing 10 for a sturdy and flexible support structure. The material of the two removable plastic tubing 9, 10 is polyethylene. The marching drum stability and mobility support belt 1 can further comprise the outside Velcro® attachments 8 on the one large piece layer of neoprene 3 on the obverse side of the support belt 1 by sewing with heavy-duty thread.

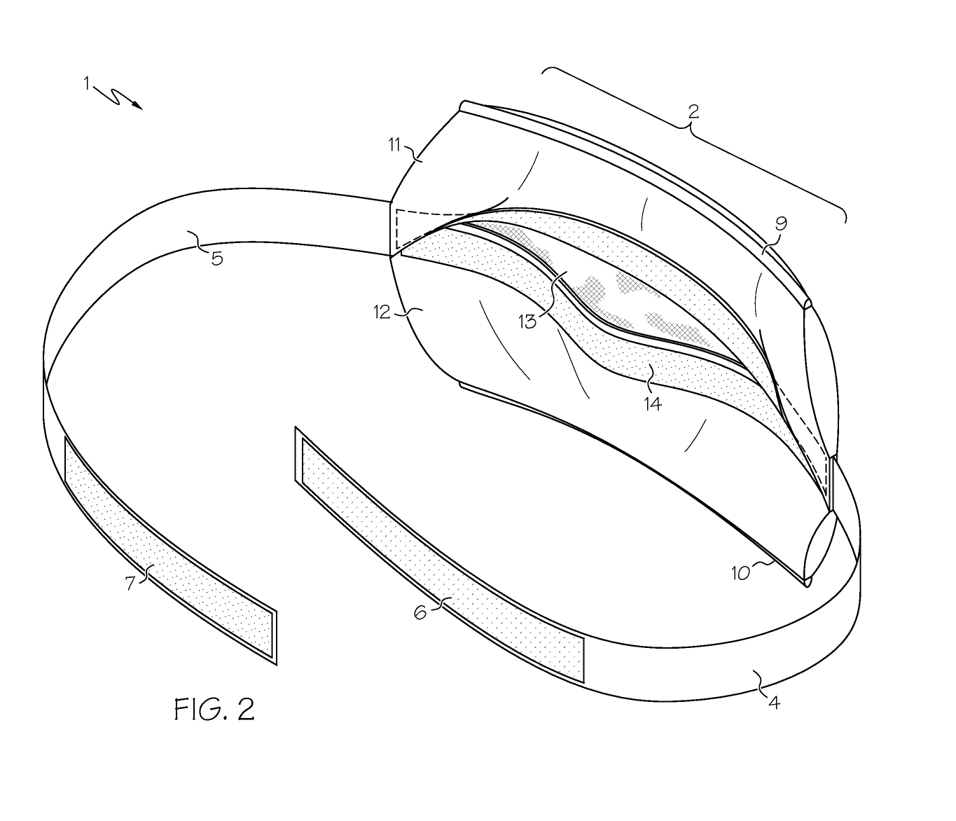

FIG. 2 shows an elevational perspective view of the inverse side of a marching drum, stability and mobility support belt 1 in the open position according to an example embodiment of the present invention shown in FIG. 1. The support belt 1 comprises a support mechanism 2 with the capability of providing support for the posterior musculature of a users back. The support mechanism 2 can further provide a more efficient demand of the anterior musculature of the user. The support mechanism 2 can still further provide comfort for the user by reducing the amount of contact pressure at the shoulders by redistributing those pressures to the abdominal region and pelvis.

In the preferred embodiment of the invention, the marching drum stability and mobility support belt 1 comprises a left side strap 4 and a right side strap 5 capable of attaching at the edges of the support belt 1 by sewing with heavy-duty thread. The two straps 4, 5 comprising a left side Velcro® attachment 6 and a right side Velcro® attachment 7 on each strap by sewing with heavy-duty thread. The materials of the two straps 4, 5 are nylon and polyester.

The support belt 1 further comprises two smaller detachable separate overlapping layers of neoprene at the top 11 and at the bottom 12 of the inverse side, enclosing two removable commercial grade closed cell foam sheets 13. The two commercial grade closed coli foam sheets 13 can be removed to allow the support belt 1 to be cleaned.

The two detachable separate overlapping layers of neoprene at the top 11 and bottom 12 of the inverse side are capable of connecting by a strip of Velcro® attachment 14. The marching drum stability and mobility support belt 1 further comprises a top removable plastic tubing 9 and a bottom removable plastic tubing 10 for a sturdy and rigid support structure with the flexibility to lie along the curvature of the user's back. The material of the two removable plastic tubing 9, 10 is polyethylene.

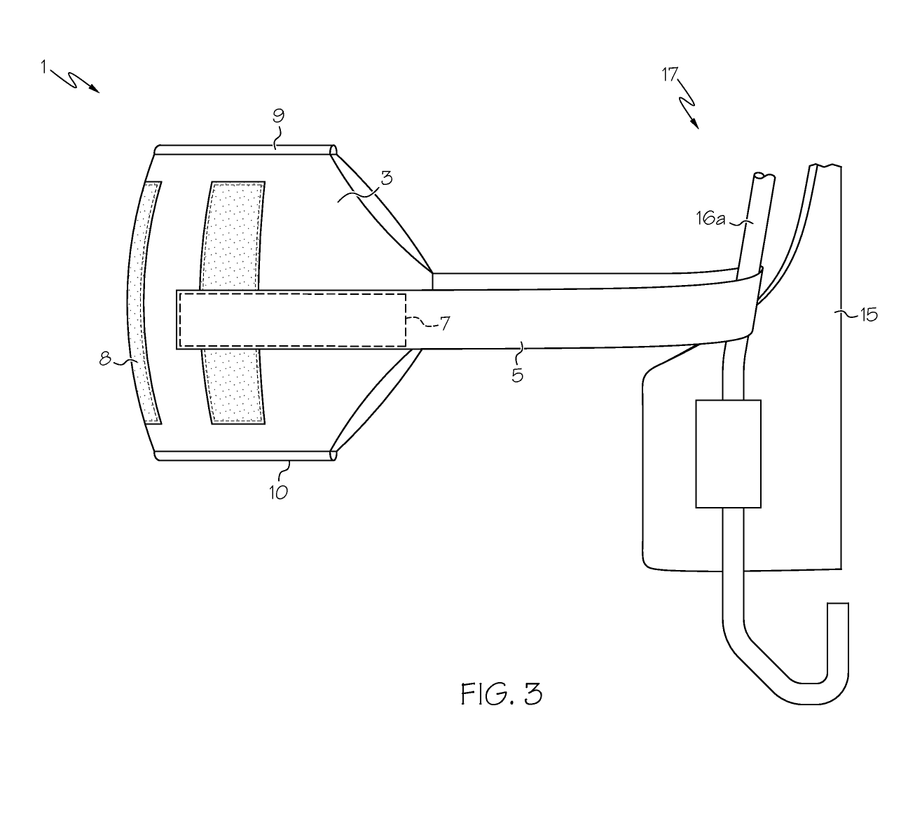

FIG. 3 is an enlarged fragmented side elevational perspective view of a marching drum stability and mobility support belt 1 in the fastened position attaching via the right side strap Velcro® attachment 7 around a marching drum carriage apparatus 17. The support belt 1 of the present invention is capable of attaching to a plurality of points on the marching drum carriage apparatus 17.

The plurality of points on the marching drum carriage apparatus 17 can be of multiple areas including, but not limited to, the J-rods 16a, the tubular members 16b, T-bar or the like. As shown, the present area of interest on the marching drum carriage apparatus 17 is the J-rod 16a, which is connected to the abdominal plate 15 of the apparatus 17.

The right side strap 5 is extending from the marching drum stability and mobility support belt 1 and fastened by looping around the J-rod 16a of the marching drum carriage apparatus 17 and connecting back onto the support belt 1 and onto the outside Velcro® attachment 8 on the one large piece layer of neoprene 3 on the obverse side of the support belt 1.

The marching dart stability and mobility support belt 1 still further comprises a top removable plastic tube 9 and a bottom removable plastic tube 10 for a sturdy and rigid support structure with the flexibility to lie along the curvature of the user's back. The material of the two removable plastic tubing 9, 10 is polyethylene.

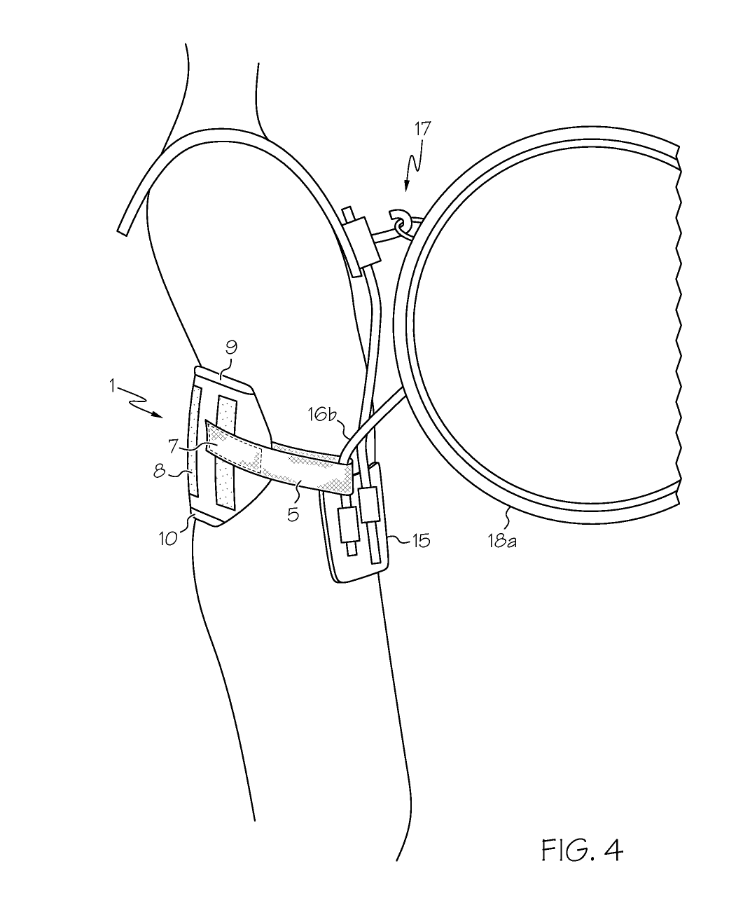

FIG. 4 shows a side perspective view of a marching drum stability and mobility support belt 1 in the fastened position attaching via the right side strap Velcro® attachment 7 to a marching drum carriage apparatus 17 worn by a marching drummer or user according to an example embodiment of the present invention. The support belt 1 of the present invention is capable of attaching to a plurality of points on a marching drum carriage apparatus 17.

The plurality of points on the marching drum carriage apparatus 17 can be of multiple areas including, but not limited to, the J-rods 16a, the tubular members 16b, T-bar or the like. As shown, the present area of interest on the marching drum carriage apparatus 17 is the tubular member 16b, which is connected to the abdominal plate 16 of the apparatus 17.

The right side strap 6 is extending from the marching drum stability and mobility support belt 1 and fastened by looping around the tubular member 16b of the marching drum carriage apparatus 17 and connecting back onto the support belt 1 via the outside Velcro® attachment 8 on the obverse side of the support belt 1.

The marching drum carriage apparatus 17 is a marching drum carrier capable of attaching to and supporting a plurality of drums including, but not limited to, a snare drum 18b, tenor drum, bass drum 18a or the like. As shown, the support belt 1 is fastened to a marching drum carrier worn by the drummer around the tubular member 16b, and the drum carrier is attaching to and supporting a bass drum 18a.

The marching drum stability and mobility support belt 1 further comprises a top removable plastic tube 9 and a bottom removable plastic tube 10 for a sturdy and flexible support structure. The material of the two removable plastic tubing 9, 10 is polyethylene.

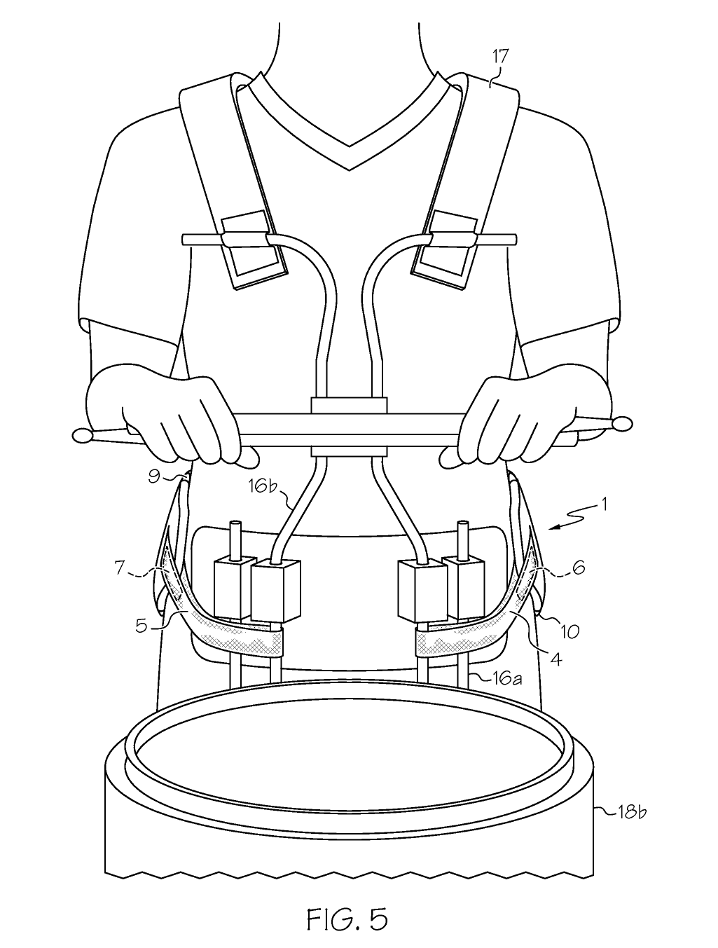

FIG. 5 shows a front perspective view of a marching drum stability and mobility support belt 1 in the fastened position attaching via Velcro® to a marching drum carrier worn by a marching drummer or user according to an example embodiment of the present invention. The left side strap 4 and the right side strap 5 are extending from the marching drum stability and mobility support belt 1 and fastening around the plurality of points on the marching drum carriage apparatus 17 and connecting back onto the obverse side of the support belt 1.

The plurality of points on the marching drum carriage apparatus 17 can be of multiple areas including, but not limited to, the J-rods 16a, the tubular members 16b, T-bar or the like. As shown, the present areas of interest on the marching drum carriage apparatus 17 are the tubular members 16b, which are connected to the abdominal plate 15 of the apparatus 17.

The marching drum carriage apparatus 17 is a marching drum carrier capable of attaching to and supporting a plurality of drums including, but not limited to, a snare drum 18b, tenor drum, bass drum 18e or the like. As shown, the support belt 1 is fastened to a marching drum carrier worn by the drummer around the tubular members 16b, and the drum carrier is attaching to and supporting a snare drum 18b.

The marching drum stability and mobility support belt 1 further comprises a top removable plastic tube 9 and a bottom removable plastic tube 10 for a sturdy and flexible support structure. The material of the two removable plastic tubing 9, 10 is polyethylene.

While at least one exemplary embodiment of the present invention has been presented in the foregoing detailed description, it should be appreciated that a vast number of variations exist. The specific embodiments as disclosed and illustrated herein are not to be considered in a limiting sense. It should be apparent and understood to persons skilled in the art that what is presented herein may be modified in numerous ways. It is only indicated by the appending claims, including all equivalents, which are intended to define the scope of this invention.

What is claimed is:

1. An anterior load carriage stability and mobility support system, comprising:
a body, comprising:
a support mechanism, wherein the said support mechanism is for the lumbar region of a user's back; and
a fastening means.

2. The anterior load carriage stability and mobility support system according to claim 1, wherein the said support mechanism comprises one large piece and two small separate pieces.

3. The anterior load carriage stability and mobility support system according to claim 2, wherein the material of the said one large piece and two small separate pieces is neoprene fabric.

4. The anterior load carriage stability and mobility support system according to claim 3, wherein the said two small separate neoprene pieces are overlapping layers attaching by at least one Velcro® strip.

5. The anterior load carriage stability and mobility support system according to claim 4, wherein the said two small separate overlapping neoprene layers encompass at least one removable sheet of commercial grade closed cell foam.

6. The anterior load carriage stability and mobility support system according to claim 5, wherein the said at least one removable sheet of commercial grade foam is capable of providing support for the lumbar region of a user's back.

7. The anterior load carriage stability and mobility support system according to claim 1, wherein the said support mechanism comprises at least one strap.

8. The anterior load carriage stability and mobility support system according to claim 7, wherein the materials of the said at least one strap are nylon and polyester.

9. The anterior load carriage stability and mobility support system according to claim 1, wherein the said support mechanism comprises at least one removable plastic tubing providing for a sturdy and rigid support structure with the flexibility to lie along the curvature of the user's back.

10. The anterior load carriage stability and mobility support system according to claim 9, wherein the material of the said at least one removable plastic tubing is polyethylene.

11. The anterior load carriage stability and mobility support system according to claim 1, wherein the said fastening means is capable of reversibly fastening the said support mechanism to a plurality of points on an anterior load carriage apparatus.

12. The anterior load carriage stability and mobility support system according to claim 11, wherein the said fastening means are extending from the at least one strap of the said support mechanism to the said plurality of points on the said anterior load carriage apparatus, comprising one of Velcro®, a buckle, a clasp or the like.

13. The anterior load carriage stability and mobility support system according to claim 12, wherein the said fastening means from the said at least one strap is capable of looping around the said plurality of points on the said anterior load carriage apparatus and connecting back via the outside Velcro® attachment on the obverse side of the said support mechanism.

14. The anterior load carnage stability and mobility support system according to claim 13, wherein the said plurality of points on the said anterior load carriage apparatus include, but are not limited to, the J-rods, the tubular members, T-bar or the like.

15. The anterior load carriage stability and mobility support system according to claim 12, wherein the said anterior load carriage apparatus is of a plurality of devices and fields including, but not limited to, a marching band patient assistance and transport, general load carrying or the like.

16. The anterior load carriage stability and mobility support system according to claim 14, wherein the said anterior load carriage apparatus is a marching drum carrier.

17. The anterior load carriage stability and mobility support system according to claim 16, wherein the said marching drum carrier is capable of attaching to and supporting a plurality of drums including, but not limited to, a snare drum, tenor drum, bass drum or the like.

18. The anterior load carriage stability and mobility support system according to claim 1, wherein the said support mechanism is capable of providing support for the posterior musculature of the users trunk and pelvis including, but not limited to, the erector spinae.

19. The anterior load carriage stability and mobility support system according to claim 18, wherein the said support mechanism can further provide a more efficient demand of the anterior musculature of the user including, but not limited to, the abdomen or pelvis.

20. The anterior load carriage stability and mobility support system according to claim 19, wherein the said support mechanism can further provide comfort for the user by reducing the amount of contact pressure at the shoulders by redistributing those pressures to the abdominal region and pelvis.
